(19) United States
(12) Patent Application Publication
(10) Pub. No.: US 2005/0041661 A1
(43) Pub. Date: Feb. 24, 2005

(54) PCR timing control in variable bit rate (VBR) transport streams

(76) Inventors: Thomas M. Thorsteinson, Winnipeg (CA); J. Desmond Bean, Winnipeg (CA); David T. Shimizu, Winnipeg (CA); George Cosens, Winnipeg (CA); Kumaran Subramoniam, Winnipeg (CA)

Correspondence Address: ADE & COMPANY, 1700-360 MAIN STREET, WINNIPEG, MB, R3C3Z3, CA

(21) Appl. No.: 10/901,299

(22) Filed: Jul. 29, 2004

Related U.S. Application Data
(60) Provisional application No. 60/490,542, filed on Jul. 29, 2003.

(51) Int. Cl. H04L 12/56

(52) U.S. Cl. 370/389

(57) ABSTRACT

In a method for transmitting data in packets in a transport stream the temporal relationship is stored in memory with each of the packets in that a timestamp is attached to each packet that reflects the exact arrival time of a data element of the packet. To accomplish this, a firmware counter called the Receive Timing Register (RTR) is clocked by a local oscillator to generate a Receive Timing Register value at the time the PCR reference bit arrives to create a timestamp that is associated with each packet. The oscillator and firmware register are located on the card that receives the stream. Alternatively stuffing is applied to each packet to control the transmission rate by the length of the sequentially transmitted packets. This can be done at alternating faster and slower rates or can be applied between PCR packets.

This invention relates to a method for transmitting data in packets in a transport stream and particularly but not exclusively to packets used in MPEG-2 transport streams sent over DVB-ASI.

### BACKGROUND OF THE INVENTION

MPEG-2 transport streams can carry multiple programs, each of which can contain multiple elements. The rate of the overall transport stream may be constant, but this may not be true for individual programs in the stream. A program may be composed of multiple segments spliced together, such as commercials which interrupt the main program. Each segment may be produced at a different bit rate using a different encoder and production equipment. If the individual programs are filtered from a multi-program stream and saved to disk, then the timing of the overall transport stream is lost. The individual program cannot be replayed by using a constant bit rate control, because the bit rate may vary from segment to segment.

The program clock reference (PCR) fields in MPEG-2 transport streams may not always arrive at the intended times. Dispersion of the timing can happen when the stream passes through processing equipment such as multiplexers, network interfaces, modulators, satellite transmission systems, rate adapters and disk storage. This “jitter” in the PCR timing can cause artifacts and distortions in the decoded video and audio.

### SUMMARY OF THE INVENTION

It is one object of the invention to provide a method using software and firmware algorithms to allow these programs to be played at variable bit rate.

According to one aspect of the invention there is provided a method for transmitting data in packets in a transport stream comprising:

receiving data at a receive station in sequential packets where at least some of the packets include timing information;

entering the packets into a memory storage system at the receive station which stores the packets in a form where the timing information is lost;

generating at the receive station a timestamp for each packet;

attaching the time stamp to the packet prior to entering into the memory such that the time stamp is stored in the memory with the packet;

extracting the packets with the time stamp associated therewith sequentially for transmission;

and transmitting the packets from the receive station sequentially at times dependent on the time stamp with the time stamp removed.

In one preferred arrangement, the time stamp for each packet reflects the exact arrival time of a data element of the packet at the receive station.

Where at least some of the packets include a PCR reference bit, the time stamp is preferably created at the time the PCR reference bit arrives at the receive station.

Preferably these steps are achieved by a receive timing register is provided and the value of the receive timing register at the time the data element of the packet arrives is used to create the timestamp.

Preferably the receive timing register which is clocked by a local oscillator is provided on firmware to generate the time stamp.

Preferably the oscillator and firmware register are located on a card that receives the stream.

In an alternative preferred arrangement, some of the packets are PCR packets which have PCR data which determines a required time of transmission and there are between each PCR packet and the next a plurality of packets which have no PCR data and wherein the time stamps of the PCR packets are generated in response to a detection of the PCR data of the packet and the time stamps of the plurality of packets which have no PCR data are interpolated therefrom.

Preferably the packets are transmitted by a transmitter circuit which uses the local oscillator as a timing reference for a transmit timing register.

Preferably the timestamp of the first packet is used to initialize the transmit timing register.

Preferably the timestamp of all other packets is compared to an instantaneous transmit timing register value and holds the packets until the timestamp and the transmit timing register value are equal.

Preferably the oscillator and firmware register are located on a card that receives the stream which is associated with a separate computer which contains the programming for the operation.

According to a second aspect of the invention, there is provided a method for transmitting data in packets in a transport stream at a transmission rate approximating a required stream rate comprising:

receiving data at a receive station in sequential packets where at least some of the packets include timing information;

entering the packets into a memory storage system at the receive station;

extracting the packets from the memory storage system sequentially for transmission;

and transmitting the packets from the receive station sequentially;

wherein prior to transmission, at least some of the packets have attached thereto stuffing characters which define a predetermined total length for the packet such that sequential transmission of the packets of the predetermined length defines a rate of transmission approximating to the required stream rate.

In this method preferably the stuffing is attached such that the rate of transmission of a plurality of the packets is consistently different from the required rate.

Preferably the rate is higher than the required rate but it can be lower.

Preferably the rate is different by an amount which allows the packets to be received and handled and which gradually increases a transmission rate error.

In the situation where some of the packets are PCR packets which have PCR data which determines a required time of transmission and there are between each PCR packet and the next a plurality of packets which have no PCR data preferably the stuffing is attached to the packets with no PCR data such that the rate of transmission of the plurality of the packets is consistently different from the required rate.

In an alternative arrangement where the PCR data is not used, the packets are transmitted for a first period at a rate which is slightly greater than the required rate and for a second period at a rate which is slightly less than the required rate.

In this arrangement, preferably the lower rate is arranged to be I where I is an integer below required rate and the higher rate is I plus one.

In this arrangement, preferably the packets are transmitted for a plurality of first periods at a rate which is slightly greater than the required rate and for a plurality of second periods at a rate which is slightly less than the required rate, where the first and second periods are alternated.

Preferably the lengths of the first and second periods are different.

Preferably the lengths of the first and second periods are proportional to INSERT.

The methods described here preferably use a combination of firmware located on a card attached to an ordinary computer, and a software program running on the host computer.

This method can be used for storing and playing back complete or partial MPEG-2 transport streams. It replays MPEG-2 transport stream packets from disk while preserving the original timing of each packet. This method will not improve the PCR jitter of the original stream.

### BRIEF DESCRIPTION OF THE DRAWINGS

One embodiment of the invention will now be described in conjunction with the accompanying drawings in which:

FIG. 1 is a schematic illustration of a packet with the pre-pended time stamps TS attached thereto according to the present invention.

FIG. 2 is a schematic illustration of a method for transmitting the packets by detecting the time stamps and transmitting the packets with the time stamps removed, where the firmware waits for packet maturity, that is when TR matches TS, before releasing the packet with TS stripped.

FIG. 3 is a schematic illustration of a first method for inputting the packets by detecting the arrival time of the packets at the receive station and generating time stamps related to the arrival time which are stored in the memory with the packets.

FIG. 4 is a schematic illustration of a second method for inputting the packets by generating time stamps which are stored in the memory with the packets, where the software does a discontinuity check finds the PCR packet and reads the PCR value, sets TS equal to PCR and if there is a discontinuity sets the indicator, and where the firmware waits for a packet maturity where TR equals TS, strips TS and resets TR if there is a discontinuity.

FIG. 5 is a graph of time versus Packet arrival Time error showing the method in which the rate of non-PCR packets are transmitted at a rate which is slightly higher than the required average rate.

FIG. 6 is a graph of time versus Packet arrival Time error showing the method in which the packets are transmitted at alternating rates in periods P1, P2, P3, P4 and P5 etcetera which are slightly higher in P1, P3 and P5 than the required average rate and slightly lower in P2 and P4 than the required average rate and wherein the periods are different.

FIG. 7 is a schematic illustration of the data elements of an MPEG-2 packet.

### DETAILED DESCRIPTION

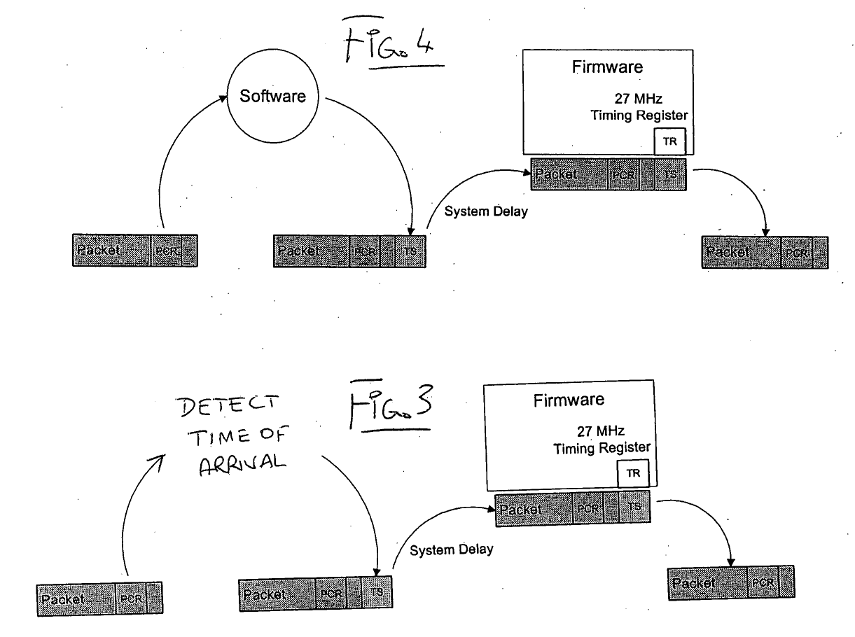

In the first method shown in FIG. 3, an incoming live MPEG-2 transport stream is to be captured to a disk. The packets containing PCR data defining the required timing have their PCR data in the stream are generated from a 27 MHz timing reference. The object is to reproduce the original temporal relationship between the PCR data in the stream after it is stored on the computer.

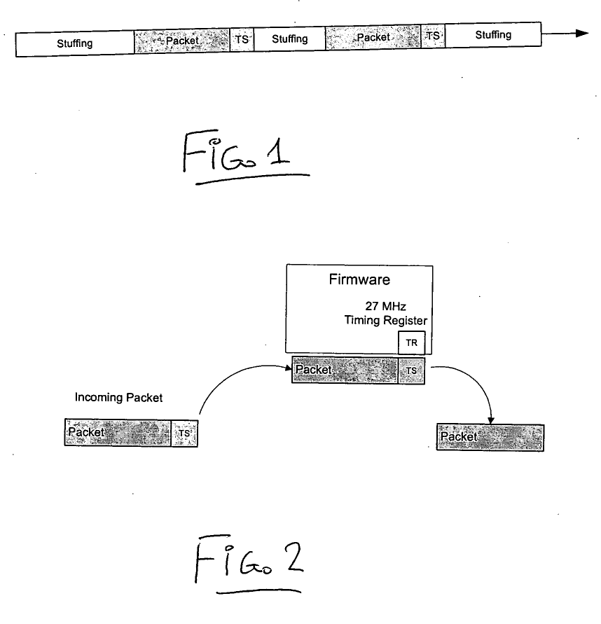

When the raw stream is stored on the computer or other storage system, the timing relationship between the packets is lost. For example, conventionally, if the incoming stream is carried by DVB-ASI then stuffing characters are used as shown in FIG. 1 to control the spacing between packets. When these are stored they are stripped out in the process of receiving the stream so that, when the stream is stored, the packets are packed tightly together in memory and the temporal relationship is lost.

In the present arrangement, the packets are stored with a time stamp which is generated to reflect timing information and is stored in memory with the packet.

In a first method shown in FIG. 3, the temporal relationship is stored with each of the packets in that a timestamp is attached to each packet that reflects the exact arrival time. To accomplish this, a firmware counter called the Receive Timing Register (RTR) is clocked by a local oscillator to generate timing information. The firmware uses the Receive Timing Register value at the time the PCR reference bit arrives to create a timestamp (TS) that is associated with each packet. This, in effect, stores the arrival time of the PCR reference bit of each packet as shown in FIG. 1. The oscillator and firmware register are located on the card that receives the stream.

An alternative which is defined as a Timed Release Method of PCR Timing Control can be used to play back an MPEG-2 transport stream stored on a storage medium such as a disk. It regenerates the intended timing of each packet, and does not require the packets to be time stamped at arrival. The original timing of the packets is lost.

In this method, an MPEG-2 transport stream is stored on a storage device. An application program examines each packet as the file is read from the storage device. When a packet containing a PCR from one selected program is found, the PCR is converted to a timestamp (TS) value and associated with that packet. All other packets are associated with a timestamp that is linearly interpolated from the two surrounding PCR packet timestamps.

The software also examines the PCR packets for time-base discontinuities. When a PCR packet with a time-base discontinuity is found, a discontinuity flag is associated with that packet. The timestamps of the non-PCR packets immediately preceding this PCR packet are linearly extrapolated from the two previous PCR packet timestamps. The first packet of a stream is always flagged as a discontinuity.

The transport stream, timestamps, and discontinuity flags are passed to a computer card. Whenever a discontinuity flag is associated with a packet, the card initializes the Transmit Timing Register (TTR) with that packet's timestamp value. It then discards the timestamp and transmits the packet. For all other packets, the card delays transmission until the Transmit Timing Register value is equal to the packet timestamp. The Transmit Timing Register is clocked by a local oscillator whose frequency is chosen such that this algorithm will reproduce the nominal 27 MHz system clock frequency represented by the PCRs. The entire process is illustrated in FIG. 3.

On playback, a transmitter circuit uses the local oscillator as a timing reference for a Transmit Timing Register. The packets are retrieved from the memory in the same order that they were stored. On playback, the timestamp of the first packet is used to initialize the Transmit Timing Register. The firmware compares the timestamp of all other packets to the Transmit Timing Register value and holds the packets until they are “mature”. Maturity occurs when the timestamp and the Transmit Timing Register value are equal. The timestamp is then discarded and the packet is transmitted. This process continues until all packets have been retrieved and transmitted from the file.

Although this description has referenced MPEG-2 transport streams sent over DVB-ASI, the basic method could be used with any packet oriented data on any fixed rate interface that uses special characters to fill in unused portions of the link.

As an alternative to interpolating timestamps for non-PCR packets, it is possible to simply transmit them at a constant rate slightly faster than the rate prescribed by the PCRs. This does not comply with the MPEG-2 transport stream specification, but for a single-program transport stream the result will be acceptable to many pieces of equipment.

The “stuffing parameters” described hereinafter are used to limit the maximum transmission rate of the stream. Non-PCR packets have their timestamps set such that they always appear to be mature, and are transmitted at the maximum rate. PCR packets would still be delayed until the Transmit Timing Register value equals their timestamp.

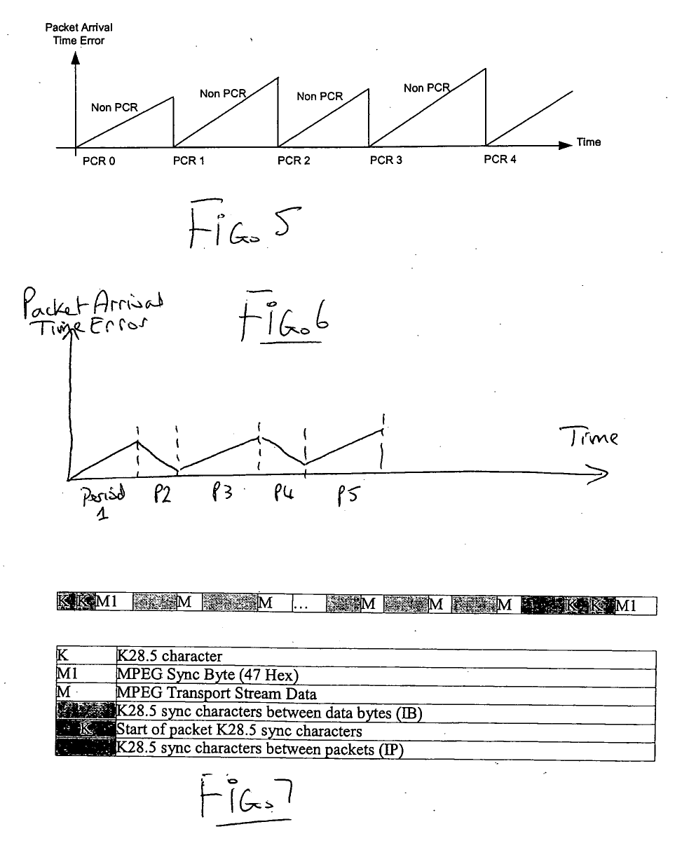

FIG. 5 illustrates the effect of the stuffing method on the overall rate of the stream.

When playing MPEG files back from memory, the Timed Release method shown schematically in FIG. 5 can be used to control the rate of the stream and re-create the original timing of the stream.

The Timed Release method of PCR timing control can also be used to lower the PCR jitter of a live MPEG transport stream. The timing of PCRs in a transport stream can be disturbed in many ways as the stream passes through different devices used in video production. Modulators and rate adapters can add null packets and encapsulators can add PIDs to the stream. Improper restamping of the PCRs can add PCR timing jitter to the stream and once there it is hard to remove.

The Timed Release method shown in FIG. 6 and described hereinafter can regenerate the original PCR timing. If the original encoders generated the PCR data properly then the jitter of the stream can be recovered to something close to the values produced by the original encoder.

MPEG-2 transport stream data is sent over a DVB-ASI link as 8B/10B encoded data interspersed with a special 8B/10B character called K28.5 transmitted at 270 Mbits/sec. The K28.5 characters are used by the interface to define byte synchronization and to fill the unused portion of the link. Each transport stream packet is always preceded by two K28.5 characters as shown in FIG. 7.

The time to transmit one transport stream packet is

$$PT = \frac{PS + 2 + IP + ( PS - 1 ) * IB}{27 , 000 , 000} ( seconds )$$

Where

PT=packet time in seconds

IB=number of K28.5 characters between data bytes of a single packet

IP+2=number of K28.5 characters between the last data byte of one packet and the sync byte of the next packet

PS=packet size in bytes

BR=transport stream bit rate in bits per second

The bit rate of the MPEG-2 transport stream before 8B/10B encoding is

$$BR = \frac{27 , 000 , 000 * 8 * PS}{PS + 2 + IP + ( PS - 1 ) * IB} ( bits per second )$$

For a transport stream of a given bit rate, the values of IB and IP can be calculated as follows.

IB must be less than:

$$IB ( max ) = \frac{8 * 27 , 000 , 000}{BR} - 1$$

Once the value for IB is chosen, the average value of IP needed for a given bit rate is

$$IP ( av ) = \frac{8 * 27000000 * PS}{BR} - PS - 2 - ( PS - 1 ) * IB$$

IP(av) will probably be a real number rather than an integer. The real number can be approximated by sending some packets with IP stuffing characters between packets and some packets with IP+1 stuffing characters between packets, where IP is the integer portion of IP(av). If we represent these packet counts by FT0 and FT1, the values of FT0 and FT1 are chosen by finding two integers that closely satisfy one of the following (equivalent) equations:

$$\begin{matrix}FT0 = \frac{FT1 * ( IP + 1 - IP ( AV ) )}{IP ( av ) - IP} \\ or \\ FT1 = \frac{FT0 * ( IP ( av ) - IP )}{IP + 1 - IP ( av )}\end{matrix}$$

Although the above method of sending transport stream packets can achieve a high degree of accuracy for a given bit rate transport stream, a problem arises as the values of FT0 and FT1 increase. The time shift in the start of the packet caused by varying the number of inter-packet stuffing bytes introduces jitter into the timing of the PCRs. If this jitter becomes too large, the far end decoder's phase locked loop may not be able to accurately reconstruct the original program clock from the PCRs.

This time shift can be reduced to acceptable levels by sending smaller interleaved groups of packets with IP and IP+1 stuffing, as long as the ratio remains the same. IL0 and IL1 are integers representing the maximum number of packets to be sent at one time with IP and IP+1 stuffing respectively. IL0 and IL1 must be kept quite small compared to FT0 and FT1 but the ratio of IL0 to IL1 should be approximately the same as the ratio of FT0 to FT1.

For example, if FT0=24 and FT1=75 then the values for IL0 and IL1 would be IL0=1 and IL1=3. The packets are then sent in the following order:

IL0 packets with IP stuffing characters between packets,

IL1 packets with IP+1 stuffing characters between packets,

IL0 packets with IP stuffing characters between packets,

IL1 packets with IP+1 stuffing characters between packets, etc, until FT0 packets have been sent with IP stuffing and FT1 packets have been sent with IP+1 stuffing. Then the whole process is repeated until all of the packets in the transport stream have been sent. This method is illustrated schematically in FIG. 6.

The values for IB, IP, FT0, FT1, IL0, and IL1 can be stored in registers to control a state machine that controls the timing of the bytes sent to the 8B/10B encoder on the DVB-ASI interface.

Although this description has referenced MPEG-2 transport streams sent over DVB-ASI, the basic method could be used with any packet oriented data on any fixed rate interface that uses special characters to fill in unused portions of the link.

Since various modifications can be made in my invention as herein above described, and many apparently widely different embodiments of same made within the spirit and scope of the Claims without department from such spirit and scope, it is intended that all matter contained in the accompanying specification shall be interpreted as illustrative only and not in a limiting sense.

1. A method for transmitting data in packets in a transport stream comprising:
receiving data at a receive station in sequential packets where at least some of the packets include timing information;
entering the packets into a memory storage system at the receive station which stores the packets in a form where the timing information is lost;
generating at the receive station a timestamp for each packet;
attaching the time stamp to the packet prior to entering into the memory such that the time stamp is stored in the memory with the packet;
extracting the packets with the time stamp associated therewith sequentially for transmission;
and transmitting the packets from the receive station sequentially at times dependent on the time stamp with the time stamp removed.

2. The method according to claim 1 wherein the time stamp for each packet reflects the exact arrival time of a data element of the packet at the receive station

3. The method according to claim 2 wherein at least some of the packets include a PCR reference bit and the time stamp is created at the time the PCR reference bit arrives at the receive station.

4. The method according to claim 2 wherein a receive timing register is provided and the value of the receive timing register at the time the data element of the packet arrives is used to create the timestamp.

5. The method according to claim 4 wherein the receive timing register which is clocked by a local oscillator is provided on firmware to generate the time stamp.

6. The method according to claim 5 wherein the oscillator and firmware register are located on a card that receives the stream.

7. The method according to claim 1 wherein some of the packets are PCR packets which have PCR data which determines a required time of transmission and there are between each PCR packet and the next a plurality of packets which have no PCR data and wherein the time stamps of the PCR packets are generated in response to a detection of the PCR data of the packet and the time stamps of the plurality of packets which have no PCR data are interpolated therefrom.

8. The method according to claim 1 wherein the packets are transmitted by a transmitter circuit which uses the local oscillator as a timing reference for a transmit timing register.

9. The method according to claim 8 wherein the timestamp of the first packet is used to initialize the transmit timing register.

10. The method according to claim 9 wherein the timestamp of all other packets is compared to an instantaneous transmit timing register value and holds the packets until the timestamp and the transmit timing register value are equal.

11. The method according to claim 1 wherein the oscillator and firmware register are located on a card that receives the stream which is associated with a separate computer which contains the programming for the operation.

12. A method for transmitting data in packets in a transport stream at a transmission rate approximating a required stream rate comprising:
receiving data at a receive station in sequential packets where at least some of the packets include timing information;
entering the packets into a memory storage system at the receive station;
extracting the packets from the memory storage system sequentially for transmission;
and transmitting the packets from the receive station sequentially;
wherein prior to transmission, at least some of the packets have attached thereto stuffing characters which define a predetermined total length for the packet such that sequential transmission of the packets of the predetermined length defines a rate of transmission approximating to the required stream rate.

13. The method according to claim 12 wherein the stuffing is attached such that the rate of transmission of a plurality of the packets is consistently different from the required rate.

14. The method according to claim 12 wherein the rate is higher than the required rate.

15. The method according to claim 12 wherein the rate is different by an amount which allows the packets to be received and handled and which gradually increases a transmission rate error.

16. The method according to claim 12 wherein some of the packets are PCR packets which have PCR data which determines a required time of transmission and there are between each PCR packet and the next a plurality of packets which have no PCR data and wherein the stuffing is attached to the packets with no PCR data such that the rate of transmission of the plurality of the packets is consistently different from the required rate.

17. The method according to claim 12 wherein the packets are transmitted for a first period at a rate which is slightly greater than the required rate and for a second period at a rate which is slightly less than the required rate.

18. The method according to claim 17 wherein the lower rate is arranged to be I where I is an integer below required rate and the higher rate is I plus one.

19. The method according to claim 12 wherein the packets are transmitted for a plurality of first periods at a rate which is slightly greater than the required rate and for a plurality of second periods at a rate which is slightly less than the required rate, where the first and second periods are alternated.

20. The method according to claim 18 wherein the lengths of the first and second periods are different.
